(19) United States
(12) Patent Application Publication
(10) Pub. No.: US 2025/0329723 A1
(43) Pub. Date: Oct. 23, 2025

(54) ELECTRODE COMPOSITION AND METHOD OF PRODUCING ELECTRODE

(71) Applicant: NANODE BATTERIES TECHNOLOGIES, LTD, Edmonton (CA)

(72) Inventors: Peter Kalisvaart, Waramenhuizen (NL); Bing Cao, Edmonton (CA)

(21) Appl. No.: 19/121,000

(22) PCT Filed: Oct. 14, 2022
(86) PCT No.: PCT/CA2022/051514

§ 371 Date: Apr. 14, 2025

(51) Int. Cl. H01M 4/38; B22F 1/145; B22F 9/04; B22F 9/10; H01M 4/134; H01M 10/054

(52) U.S. Cl. CPC H01M 4/387; B22F 1/145; B22F 9/04; B22F 9/10; H01M 4/134; H01M 10/054; B22F 2009/043; B22F 2301/30; B22F 2998/10

(57) ABSTRACT

A porous Tin (Sn) particle and its preparation method are presented in the present invention. The preparation method includes 1) an ultra-high cooling rate solidification process of a two-component metal melt, 2) milling the resulting 2-component solid metal mixture, 3) dissolving one of the metal components in an alkaline or acidic aqueous medium. The porous particles can then be used to produce a porous electrode where the porous particle is made to react with lithium or sodium and where said electrode is part of a lithium or sodium-ion battery with the aim of improving capacity and lifetime of that battery.

### REFERENCE TO RELATED APPLICATIONS

This is the national phase application of PCT/CA2022/0 51514 filed on 14 Oct. 2022, the disclosure of which is hereby incorporated by reference.

### FIELD OF THE INVENTION

The present invention relates to preparation of porous Tin particles and their preparation. These particles are applicable as a lithium of sodium storage medium used as the negative electrode in rechargeable Li- or Na-ion batteries with improved capacity and lifetime.

### BACKGROUND OF THE INVENTION

Lithium ion batteries are the dominant chemistry in the rechargeable battery market at present. In such a battery, Li ions move from the positive electrode, usually a Lithium-Transition Metal Oxide, to a negative electrode, currently graphite, when the battery is being charged. When the battery is being discharged, the ions move in the opposite direction.

A problem with the current generation of rechargeable Li-ion batteries is that the capacity of the most commonly used negative electrode material, graphite, is limited to 372 mAh/g in theory and approximately 350 mAh/g in practice. If the energy density of Li-ion batteries is to be expanded further, negative electrode materials with higher storage capacity than graphite should be considered. Silicon is commonly thought of as the most attractive alternative to graphite due to its high specific capacity of 3579 mAh/g. However, in addition to the search for higher capacity, there is also a drive for replacing Li, which has a relatively low abundance, with Na. Si cannot be alloyed with Na by electrochemical means at room temperature and neither can graphite, unless certain ether-based solvents are co-intercalated with the Na/Li ions. Therefore, high-capacity alternatives to graphite that are reactive with both Li and Na are preferred.

Tin can, theoretically, react with 4.4 equivalents of Li and 3.75 equivalents of Na, resulting in specific capacities of 993 and 847 mAh/g, respectively. Unfortunately, high capacity goes hand-in hand with high volume changes during Li/Na alloying and dealloying, often resulting in rapid capacity deterioration with cycling. A common method to alleviate problems with material pulverization and capacity degradation, is to introduce porosity into the storage material, in this case Sn, or to blend only a small percentage of the high-capacity material with graphite, in the case of Li, or so-called ‘hard carbon’ in case of Na.

There are several previous reports on porous Sn that have been published such as “porous Tin particle and preparation of the same” U.S. Pat. No. 8,343,668 where porosity is evolved naturally during the first lithiation/dilithiation cycle. This method results in a large irreversible expansion of the electrode and would cause engineering problems as a large amount of empty space would be required inside the battery can.

U.S. Pat. No. 8,911,901 “Negative electrode for non-aqueous secondary battery and non-aqueous secondary battery” describes preparation of a porous Si or Sn-based two-phase material using melt spinning, but the porosity occurs naturally and no chemical etching is used.

U.S. Pat. No. 10,476,072 “Electrodes for metal ion batteries” describes a method of producing porous Si and Sn powder using a chemical etching method. Melt spinning is mentioned as a possible way of producing the original composite. Active element content (Si or Sn) was at least 60 wt %.

U.S. Pat. No. 10,147,936 NANOPOROUS TIN POWDER FOR ENERGY APPLICATIONS describes preparation of porous Sn from Sn15Mg85 by chemical dealloying of the Mg using ammonium salt solutions. Several repetitions of the etching step are necessary to fully dealloy the Mg and generate the porous Sn.

Other prior art includes U.S. Pat. No. 767,349, U.S. Pat. Nos. 7,732,095, 7,871,727, and 10,155,484.

The present invention describes a single-step dealloying method using an alkaline aqueous etching solution of a finely dispersed composite of Sn and a sacrificial element produced by melt spinning. There are numerous reports in the open scientific literature of porous powder materials for negative electrodes in Li and Na-ion batteries using a combined melt spinning-dealloying approach. Examples include, and are in no way limited to, “The morphology-controlled synthesis of a nanoporous-antimony anode for high-performance sodium-ion batteries”, DOI:10.1039/C5EE03699B, “Morphology- and Porosity-Tunable Synthesis of 3D Nanoporous SiGe Alloy as a High-Performance Lithium-Ion Battery Anode”, DOI:10.1021/acsnano.8b00426, “Microstructure Controlled Porous Silicon Particles as a High Capacity Lithium Storage Material via Dual Step Pore Engineering”, DOI:10.1002/adfm.201800855, “Bimodal nanoporous NiO@Ni—Si network prepared by dealloying method for stable Li-ion storage”, DOI:10.1016/j.jpowsour.2019.227550, “Porous carbon-free SnSb anodes for high-performance Na-ion batteries”, DOI: 10.1016/j.jpowsour.2018.03.032. The secondary element being leached out to generate the porosity is commonly Al or Mg. However, porous Sn has not been reported using a similar combined melt spinning-chemical leaching method, except for a few of the examples from the patent literature mentioned above.

### SUMMARY OF THE INVENTION

It is an aspect of the invention to provide an electrode for a sodium-ion rechargeable battery consisting of between 60 and 95 weight % active material, between 0 and 20 weight % binder and between O and 20 weight % of an amorphous form of conductive carbon. In one embodiment the electrode is a negative electrode. In another embodiment the active material is Tin. The active material has a specific surface area of less than 5 m2/g

In yet another embodiment the active material has a high surface area and a certain degree of internal porosity achieved by leaching one or more sacrificial elements from a composite containing Sn. The composite material can have sacrificial elements selected from the group of; Al, Mg, Ca, Zn.

In another embodiment the electrode as claimed in claim 5 wherein the composite material consisting of between 50 and 100 weight % of Sn and between 0 and 50 weight % of sacrificial element.

In one embodiment the composite starting material is prepared by melt spinning. In another embodiment the composite starting material from claim 4 is prepared by melt spinning followed by ball milling.

Another aspect of this invention relates to a method to produce a porous Sn powder material, comprising a) mixing Sn and an appropriate sacrificial element that can be chemically leached;

b) consolidating a) above into mixed pellets by pressing elemental powders together in the appropriate ratio or by melting and slow cooling larger pellets of all constituent elements so that a single solid body of metal is obtained; c) the single solid body of metal obtained is then loaded into a BN crucible which is mounted inside a single-roller melt spinning apparatus; d) the single solid body of metal obtained is then heated to 800-850 deg C. and is then ejected onto a copper wheel spinning at a surface velocity of 25-60 m/s to produce a fine dispersion of the leachable element(s) and Sn; e) depending on the exact composition, the material can be leached directly in a KOH solution in water and yield >90 wt % of powder that can pass through a 325 mesh sieve; f) optionally a ball-milling treatment is necessary to get the final particle size of the porous Sn below the desired threshold of ^{˜}45 micrometers (=325 mesh); g) after immersion in the etching solution for 15-60 minutes, the resulting porous Sn material is washed with demineralized water and dried at room temperature; h) the porous Sn powder can then be used as the active material in a Li or Na-ion negative electrode, either by itself or blended with graphite or hard carbon, mixed with a suitable binder and solvent to obtain a slurry and blade-coated onto a copper foil current collector.

In another embodiment the method has a high cooling rate due to the high thermal mass of the wheel compared to the Sn-based material which results in extremely high cooling rates, often in excess of 10A6 K/s.

These and other objects and features of the invention shall now be described in relation to the drawings and description of the invention.

### BRIEF DESCRIPTION OF THE FIGURES

FIG. 1 shows an SEM micrograph of the powder with Sn and Al in a 1:1 atomic ratio from example 1 after melt spinning (a) and after milling the composite powder and subsequent leaching of the Al (b).

FIG. 2 shows the summary of the BET nitrogen adsorption analysis of the leached powder from example 1

FIG. 3 shows capacity retention data with cycling for the leached powder from example 1, using the electrode recipe outlined in example 1. The electrolyte consisted of 1M NaPF6 salt dissolved in dimethoxyethane. For comparison, capacity retention of an otherwise identical test, but with commercial 100 mesh Sn powder is also shown. Especially at higher currents, the performance of the porous powder is superior

FIG. 4 shows an SEM micrograph of the powder with Sn and Al in a 1:1 weight ratio from example 2 after melt spinning (a) and after milling the composite powder and subsequent leaching of the Al (b).

FIG. 5 shows the summary of the BET nitrogen adsorption analysis of the leached powder from example 2

FIG. 6 shows capacity retention data with cycling for the leached powder from example 2, using the electrode recipe outlined in example 2. The electrolyte consisted of 1M NaPF6 salt dissolved in dimethoxyethane. For comparison, capacity retention of an otherwise identical test, but with commercial 100 mesh Sn powder is also shown. Especially at higher currents, the performance of the porous powder is superior.

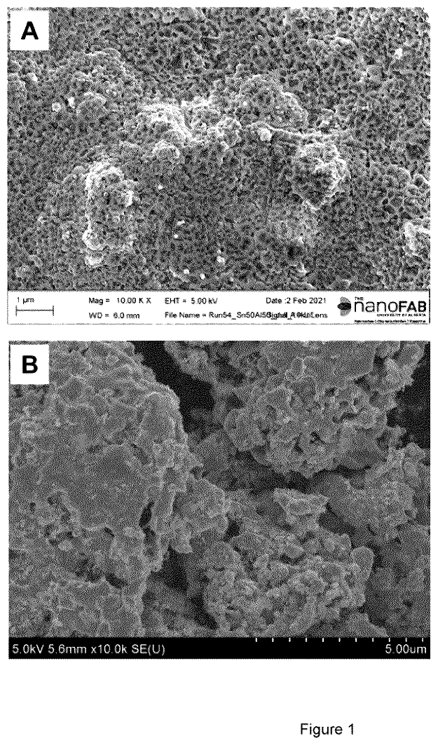

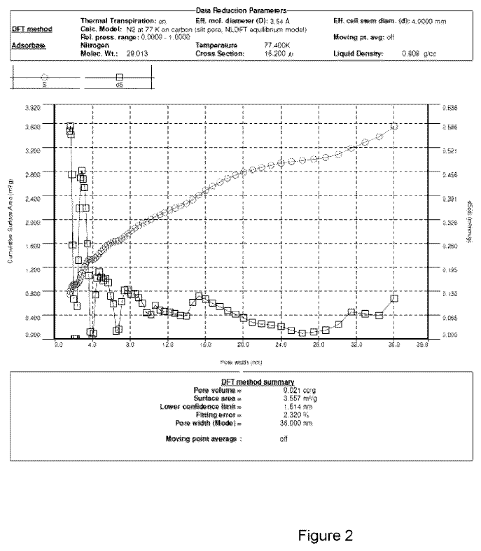

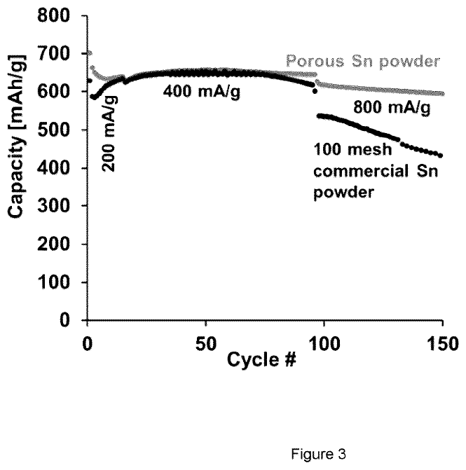

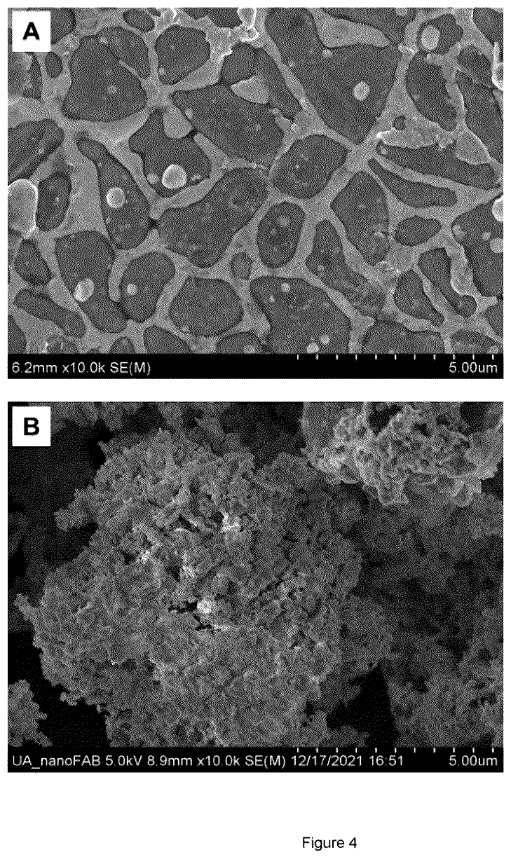

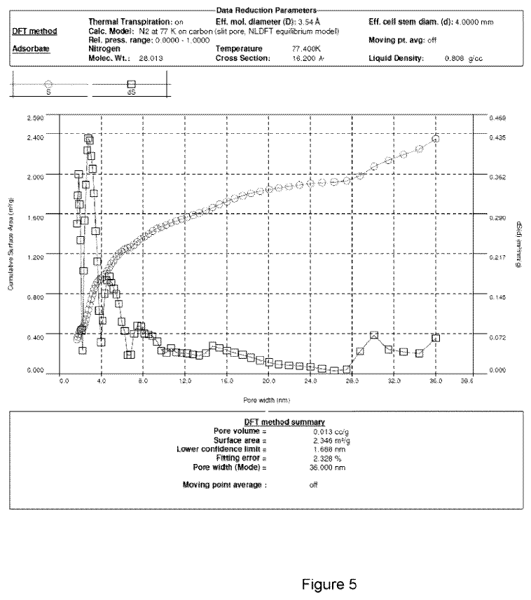

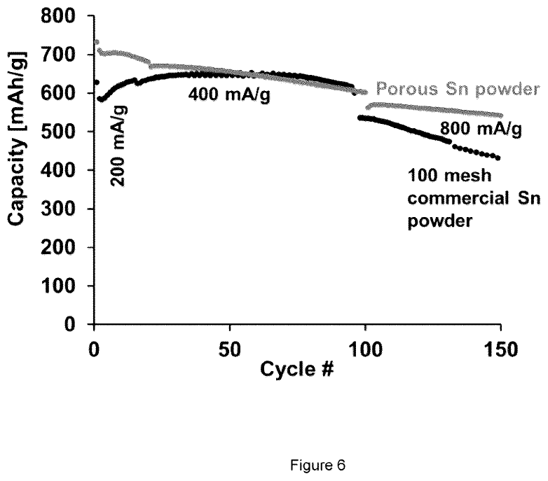

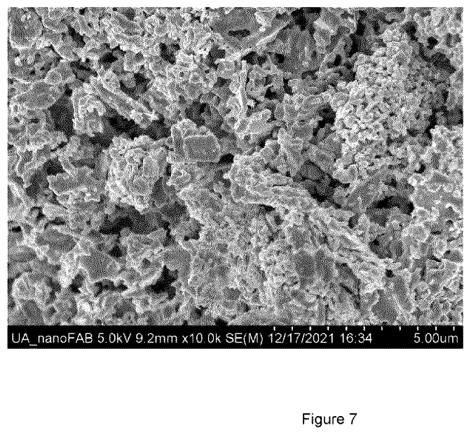

One can observe that for FIGS. 2 and 5, the left Y axis is “Cumulative Surface Area (m2/g)” (red line), right Y is “dS(d)(m2/nm/g)” (blue line). From the red line, one can have the total surface area (3.557 m2/g for the far right datapoint). From the blue line, one can have the size distribution for all the pores and make the observation that smaller pores (<5 nm) take a higher percentage than larger ones. From FIGS. 3 and 6 one can observe the cycling performance of the porous tin powder as compared to commercial tin powder. The 200, 400, 800 mA/g indicate different charging rates, so these figures show that the porous tin outperforms commercial tin, especially at higher charging rate (800 mA/g), which confirms the better fast-charging performance of porous tin.

FIG. 7 shows an SEM micrograph of the powder with Sn and Al in a 1:1 weight ratio from example 3 after leaching of the Al.

### DETAILED DESCRIPTION

While this description and examples represent several preferred embodiments of the invention, they are not meant to be exhaustive, nor are they meant to be limiting to the precise description presented herein.

To produce the porous Sn powder material, a mixture of Sn and an appropriate sacrificial element that can be chemically leached, is first consolidated into mixed pellets by pressing elemental powders together in the appropriate ratio or by melting and slow cooling larger pellets of all constituent elements so that a single solid body of metal is obtained. The resulting material is then loaded into a Boron Nitride (BN) crucible which is mounted inside a single-roller melt spinning apparatus. The material is then heated to 800-850 deg C. and is then ejected onto a copper wheel spinning at a surface velocity of 25-60 m/s. The high thermal mass of the wheel compared to the Sn-based material results in extremely high cooling rates, often in excess of 10A6 K/s. This results in a very fine dispersion of the leachable element(s) and Sn. Depending on the exact composition, the material can be leached directly in a KOH solution in water and yield >90 wt % of powder that can pass through a 325 mesh sieve. In some cases, a ball-milling treatment is necessary to get the final particle size of the porous Sn below the desired threshold of ^{˜}45 micrometers (=325 mesh). After immersion in the etching solution for 15-60 minutes, the resulting porous Sn material is washed with demineralized water and dried at room temperature. The porous Sn powder can then be used as the active material in a Li or Na-ion negative electrode, either by itself or blended with graphite or hard carbon, mixed with a suitable binder and solvent to obtain a slurry and blade-coated onto a copper foil current collector.

### Example 1

Sn and Al were mixed in a 1:1 atomic ratio and processed using a single-roller melt spinner, spinning at a surface velocity of 28 m/s. After aging the obtained ribbons in air for an appropriate length of time, the material became brittle and was subsequently milled using tungsten carbide milling tools. The rotation speed of the milling vial was set to 500 rpm for 5 hours and the weight ratio between the milling balls and the SnAl material was 20:1. The milled powder was then immersed in 1M KOH until no more hydrogen bubbling was observed, which was taken as a sign that all the Al had been dissolved. Then the powder was washed with demineralized water and dried under vacuum at room temperature. The resulting powder was characterized using a Scanning Electron Microscope (SEM) and BET. The specific surface area of the powder was 3.55 m2/g. The pore volume as determined by BET was 0.021 cc/g of pores below 36 nm diameter. The volume fraction of Al based on the nominal composition is 38.2%, which is equivalent to 0.052 cc/g.

BET stands for Brunauer-Emmett-Teller (BET) theory, which “aims to explain the physical adsorption of gas molecules on a solid surface and serves as the basis for an important analysis technique for the measurement of the specific surface area of materials” (from Wikipedia). Typically, surface area, pore size and pore volume can be obtained from BET measurements, as seen in FIGS. 2 and 5. Take FIG. 2 as an example, left Y axis is cumulative surface area (m2/g), and right Y axis can be interpreted as pore volume (m2/(nm·g)). So it indicates that smaller pores (<5 nm) take a higher percentage than larger ones.

The dried porous Sn powder was mixed with SuperP carbon black and polyvinylidene fluoride (PVDF) binder in a weight ratio of 70:15:15. N-methyl-2-pyrrolidone (NMP) solvent was added to dissolve the PVDF. After mixing for 1h in a ball mill at 500 rpm using Teflon milling vials and ZrO2 balls of various sizes, the resulting slurry was poured onto a copper foil and spread using an adjustable coating knife. After drying, coated copper foil was cut into discs of the right size (such as one cm diameter for example) that were then incorporated into 2032 coin cells for cycle life testing.

### Example 2

Sn and Al were mixed in a 1:1 weight ratio and processed using the single-roller melt spinner, spinning at a surface velocity of 28 m/s. After aging the obtained ribbons in air for an appropriate length of time, the material became brittle and was subsequently milled using tungsten carbide milling tools. The rotation speed of the milling vial was set to 500 rpm for 5 hours and the weight ratio between the milling balls and the SnAl material was 20:1. The milled powder was then immersed in 1M KOH until no more hydrogen bubbling was observed, which was taken as a sign that all the Al had been dissolved. Then the powder was washed with demineralized water and dried under vacuum at room temperature. The resulting powder was characterized using SEM and BET. The specific surface area of the powder was 2.35 m2/g. The pore volume as determined by BET was 0.013 cc/g of pores below 36 nm diameter. The volume fraction of Al based on the nominal composition is 73%, which is equivalent to 0.1 cc/g.

The dried porous Sn powder was mixed with SuperP carbon black and PVDF binder in a weight ratio of 70:15:15. NMP solvent was added to dissolve the PVDF. After mixing for 1h in a ball mill at 500 rpm using Teflon milling vials and ZrO2 balls of various sizes, the resulting slurry was poured onto a copper foil and spread using an adjustable coating knife. After drying, coated copper foil was cut into discs of the right size that were then incorporated into 2032 coin cells for cycle life testing.

### Example 3

Sn and Al were mixed in a 1:1 weight ratio and processed using the single-roller melt spinner, spinning at a surface velocity of 28 m/s. The resulting material was then immediately immersed in 1M KOH until no more hydrogen bubbling was observed, which was taken as a sign that all the Al had been dissolved. Then the powder was washed with demineralized water and dried under vacuum at room temperature. The resulting powder was characterized using SEM and BET.

1. An electrode for a sodium-ion rechargeable battery consisting of between 60 and 95 weight % active material, between 0 and 20 weight % binder and between 0 and 20 weight % of an amorphous form of conductive carbon.

2. The electrode as claimed in claim 1 wherein the electrode is a negative electrode.

3. The electrode according to claim 2 where the active material is Tin.

4. The electrode as claimed in claim 3 wherein the active material has a specific surface area of less than 5 m2/g.

5. The electrode as claimed in claim 3 wherein the active material has a high surface area and a certain degree of internal porosity achieved by leaching one or more sacrificial elements from a composite containing Sn.

6. The electrode as claimed in claim 5 wherein the composite material has sacrificial elements selected from the group of; Al, Mg, Ca, Zn.

7. The electrode as claimed in claim 5 wherein the composite material consisting of between 50 and 100 weight % of Sn and between 0 and 50 weight % of sacrificial element.

8. An active material from claim 3 where the composite starting material from claim 4 is prepared by melt spinning.

9. The active material from claim 3 where the composite starting material from claim 4 is prepared by melt spinning followed by ball milling.

10. A method to produce a porous Sn powder material, comprising:
mixing Sn and an appropriate sacrificial element that can be chemically leached;
consolidating a) above into mixed pellets by pressing elemental powders together in the appropriate ratio or by melting and slow cooling larger pellets of all constituent elements so that a single solid body of metal is obtained;
the single solid body of metal obtained is then loaded into a BN crucible which is mounted inside a single-roller melt spinning apparatus;
the single solid body of metal obtained is then heated to 800-850 deg C. and is then ejected onto a copper wheel spinning at a surface velocity of 25-60 m/s to produce a fine dispersion of the leachable element(s) and Sn;
depending on the exact composition, the material can be leached directly in a KOH solution in water and yield >90 wt % of powder that can pass through a 325 mesh sieve;
optionally a ball-milling treatment is necessary to get the final particle size of the porous Sn below the desired threshold of ^{˜}45 micrometers (=325 mesh);
after immersion in the etching solution for 15-60 minutes, the resulting porous Sn material is washed with demineralized water and dried at room temperature;
the porous Sn powder can then be used as the active material in a Li or Na-ion negative electrode, either by itself or blended with graphite or hard carbon, mixed with a suitable binder and solvent to obtain a slurry and blade-coated onto a copper foil current collector.

11. The method as claimed in claim 9 wherein the high thermal mass of the wheel compared to the Sn-based material results in extremely high cooling rates, often in excess of 1QA6 K/s.
